(19) United States
(12) Patent Application Publication
(10) Pub. No.: US 2026/0312378 A1
(43) Pub. Date: Oct. 8, 2026

(54) WIRE GRIPPER AND WIRE TENSIONING DEVICE

(71) Applicant: NAGAKI SEIKI CO., LTD., Osaka (JP)

(72) Inventor: Kosuke OKAMOTO, Osaka (JP)

(21) Appl. No.: 19/483,755

(22) PCT Filed: Dec. 5, 2023
(86) PCT No.: PCT/JP2023/043443

§ 371 Date: Nov. 12, 2025

(30) Foreign Application Priority Data
May 17, 2023 (JP) 2023-081908

(51) Int. Cl. H02G 1/04

(52) U.S. Cl. CPC H02G 1/04

(57) ABSTRACT

A wire gripper adapted to be used to grip a wire-like body, including: a wire gripping portion that includes a first and a second members, the first member including a tapered groove, the second member being arranged to be in contact with a part of the groove, thereby forming a gripping space in a gap where the second member is not in contact with the groove; a displacement mechanism configured to displace a positional aspect between the first and second members, so that the gripping space changes in size, the positional aspect including a first and a second aspects, in the first aspect, the wire-like body being gripped by the wire gripping portion, in the second aspect, gripping of the wire-like body by the wire gripping portion being released; and a motor configured to generate rotational power for imparting power to the displacement mechanism.

### CROSS REFERENCE TO RELATED APPLICATIONS

This application is a 371 U.S. National Phase of International Application No. PCT/JP2023/043443, filed on Dec. 5, 2023, which claims priority to Japanese Patent Application No. 2023-081908, filed on May 17, 2023. The entire disclosures of the above applications are incorporated herein by reference.

### BACKGROUND

### Technical Field

The present disclosure relates to a wire gripper and a wire tensioning device.

### Related Art

2018-11495A (Patent Document 1) discloses a wire gripper that can maintain a favorable gripping state even when a force is generated in the opposite direction to the tension, and that also has a function of adjusting the tension.

This wire gripper includes a wedge portion including upper and lower wedge pieces as a wire gripping mechanism. The wedge portion is held in the main body so as to surround the side surfaces in the thickness direction and the upper and lower inclined portions. The upper wedge piece has an inclined groove formed on its rear side that slidably engages with an inclined ridge formed on the main body. The lower wedge piece is connected via a separation guide portion that guides the lower wedge piece in a direction opposite to the upper wedge piece so that the lower wedge piece can approach and separate from the upper wedge piece. A base having an inclined lower guide portion formed at its upper end is interposed between the lower wedge piece and the lower portion of the main body. The upper end of an eye bolt, which is screwed into the main body, is pivotably connected to the lower end of the base.

Meanwhile, wire tensioning work is often performed at elevated locations. Accordingly, there is a demand for a wire gripper having good operability that enables the work to be performed quickly and safely. In view of the foregoing circumstances, the present disclosure provides a wire gripper and a wire tensioning device having excellent operability.

### SUMMARY

According to one aspect of the present disclosure, there is provided a wire gripper adapted to be used to grip a wire-like body. This wire gripper includes a wire gripping portion, a displacement mechanism, and a motor. The wire gripping portion includes a first member and a second member. The first member includes a tapered groove. The second member is arranged so as to be in contact with a part of the groove, thereby forming a gripping space in a gap where the second member is not in contact with the groove. The displacement mechanism is configured to displace a positional aspect between the first member and the second member, so that the gripping space changes in size. The positional aspect includes a first aspect and a second aspect. In the first aspect, the wire-like body is gripped by the wire gripping portion. In the second aspect, the gripping of the wire-like body by the wire gripping portion is released, and the motor is configured to generate rotational power for imparting power to the displacement mechanism.

According to such an aspect, the wire gripper can be operated in a simple manner, thereby enabling wire tensioning work to be performed quickly and safely.

### BRIEF DESCRIPTION OF THE DRAWINGS

FIG. 1 is a front view showing a wire tensioning device 100 according to the present embodiment.

FIG. 2 is a perspective view showing the configuration of a support 300a in FIG. 1.

FIG. 3 is a perspective view showing the configuration of a support 300b in FIG. 1.

FIG. 4 is a perspective view showing a wire gripper 1 according to the present embodiment.

FIG. 5A and FIG. 5B are perspective views showing the wire gripper 1 according to the present embodiment.

FIG. 6 is an exploded perspective view showing the configuration of a wire gripping portion 2 and a displacement mechanism 3.

FIG. 7 is an exploded perspective view showing the configuration of the wire gripping portion 2 and a wire-type detection mechanism 6.

FIG. 8 is an exploded perspective view showing the configuration of a motor 4 and a transmission mechanism 5.

FIG. 9A and FIG. 9B are left side views showing the configuration of the transmission mechanism 5.

FIG. 10 is a block diagram showing the configuration of a control board 7.

### DETAILED DESCRIPTION

Hereinafter, an embodiment of the present disclosure will be described with reference to drawings. Various features described in the embodiment below can be combined with each other.

A program for implementing a software described in the present embodiment may be provided as a non-transitory computer-readable storage medium, may be made available for download from an external server, or may be provided in such a manner that the program can be activated on an external computer to implement functions thereof on a client terminal (so-called cloud computing).

In the present embodiment, the term “unit” may also include, for example, a combination of hardware resources implemented by a circuit in a broad sense, and information processing performed by software that may be specifically implemented by such hardware resources. Furthermore, various kinds of information are handled in the present embodiment, and such information may be represented by, for example, physical values of signal values representing voltage and current, high and low signal values as a set of binary bits consisting of 0 or 1, or quantum superposition (so-called qubits), and communication and computation may be executed on a circuit in a broad sense.

Furthermore, the term “circuit in a broad sense” refers to a circuit that is implemented by appropriately combining at least one or more of a circuit, circuitry, a processor, memory, and the like. In other words, the term “circuit in a broad sense” includes an application specific integrated circuit (ASIC), a programmable logic device (e.g., a simple programmable logic device (SPLD), a complex programmable logic device (CPLD), a field programmable gate array (FPGA)), and the like.

### <Wire Tensioning Device>

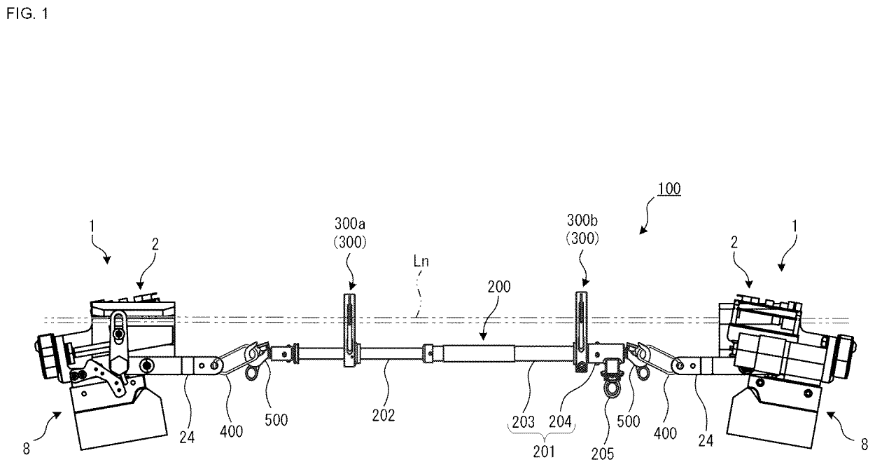

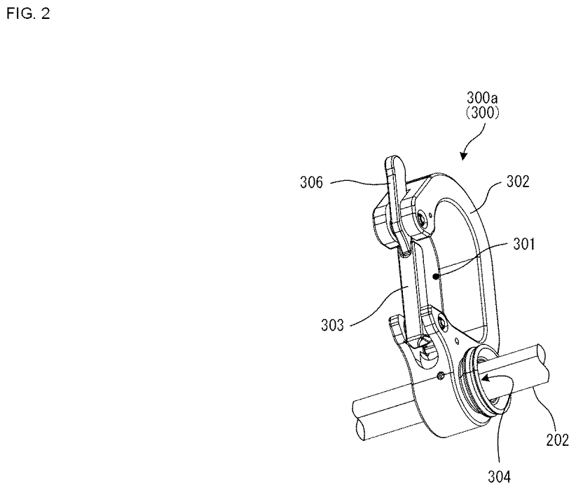

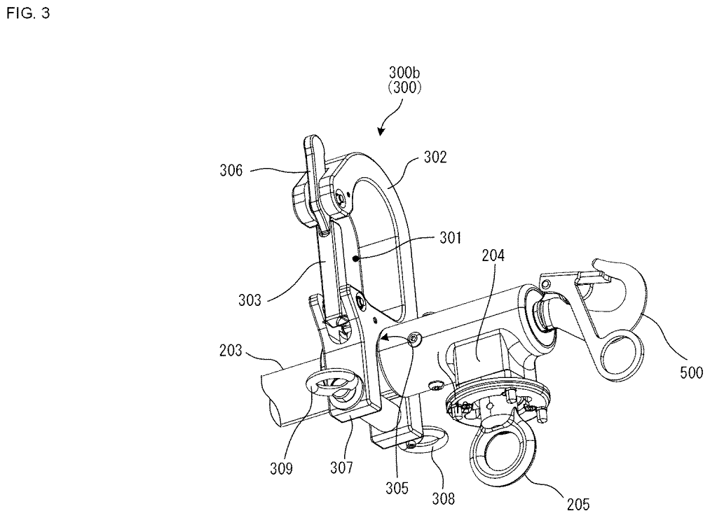

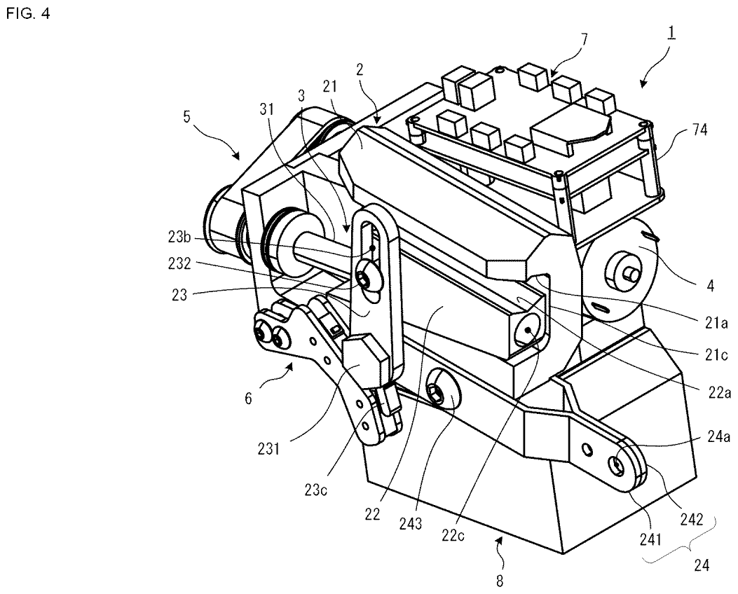

First, a wire tensioning device according to the present embodiment will be described. FIG. 1 is a front view showing a wire tensioning device 100 according to the present embodiment. FIG. 2 and FIG. 3 are perspective views showing the configuration of a support 300 in FIG. 1, respectively. In the following description, an upper side is referred to as “up” or “upward” and a lower side is referred to as “down” or “downward” in FIG. 1 to FIG. 3 (the same applies to FIG. 4 to FIG. 9). In addition, a right side is referred to as “right” or “right side” and a left side is referred to as “left” or “left side” in FIG. 1 to FIG. 3 (the same applies to FIG. 4 to FIG. 9).

The wire tensioning device 100 (also referred to as a “strain rod”) shown in FIG. 1 is used, for example, when performing work for cutting a coated electric wire that is an example of a wire-like body Ln, while it is in an aerial state. In FIG. 1, the coated electric wire is indicated by two-dot chain lines.

This wire tensioning device 100 includes a pair of wire grippers 1 for gripping the coated electric wire, which is an example of the wire-like body Ln, and a long extension/retraction device 200 whose both ends are connected to these wire grippers 1 via coupling tools 400. The extension/retraction device 200 is configured such that the longitudinal dimension thereof can be extended or retracted by operating an operation part 205 provided on the right side (another side) of the extension/retraction device 200 in the longitudinal direction.

As shown in FIG. 1, the extension/retraction device 200 includes a body cylinder portion 201 having a cylindrical shape and a small-diameter cylindrical moving shaft portion 202 inserted in the body cylinder portion 201 so as to be relatively movable in the longitudinal direction. The body cylinder portion 201 includes a cylindrical portion 203 made of, for example, aluminum or FRP (fiber-reinforced plastic), and a moving portion 204 fixed at the end of the cylindrical portion 203.

The moving portion 204 has a casing made of, for example, aluminum alloy, and a gear transmission mechanism (not shown) housed in the casing. The gear transmission mechanism is coupled to the operation part 205 that protrudes from the bottom surface of the casing and is rotated. The gear transmission mechanism is coupled to a screw shaft extending in the longitudinal direction in the cylindrical portion 203. A nut (not shown) provided at the end of the moving shaft portion 202 on the body cylinder portion 201 side is screwed with this screw shaft. The moving shaft portion 202 is formed of, for example, FRP.

When extending and retracting the extension/retraction device 200, a remote control tool (an indirect tool) is engaged with the operation part 205, and the operation part 205 is rotated by the remote control tool. This allows the screw shaft in the cylindrical portion 203 to be driven to rotate, and the moving shaft portion 202, whose nut provided at the end is screwed with the screw shaft, moves along the axial direction. As a result, the moving shaft portion 202 comes in and out from the body cylinder portion 201, so that the extension/retraction device 200 is configured to extend or retract.

The end of the extension/retraction device 200 on the body cylinder portion 201 side and the end of the extension/retraction device 200 on the moving shaft portion 202 side are each provided with a fixing member 500 capable of locking a coupling tool 400.

The wire tensioning device 100 includes a pair of supports 300 (support 300a and support 300b) attached to the extension/retraction device 200. As shown in FIG. 2 and FIG. 3, the supports 300a and 300b each include a substantially C-shaped support body 302 having an opening 301 on one side, and a closing piece 303 which closes the opening 301 of the support body 302. With such a configuration, after introducing the coated electric wire that is an example of the wire-like body Ln into the inside of the support body 302 through the opening 301, the opening 301 of the support body 302 is closed with the closing piece 303, so that the support 300 can support the coated electric wire.

In addition, an engagement piece 306 that engages with the closing piece 303 is rotatably provided in a state in which the opening 301 is closed by the closing piece 303 at the end of the support body 302 facing the opening 301.

As shown in FIG. 2, a through hole 304 through which the extension/retraction device 200 (moving shaft portion 202) is inserted is formed in the lower part of the support body 302 in the support 300a. In contrast, as shown in FIG. 3, a through hole 305 through which the extension/retraction device 200 (cylindrical portion 203) is inserted is formed in the lower part of the support body 302 in the support 300b.

In addition, the support 300b is provided with a fixing portion 307 in the lower part of the support body 302 for fixing the extension/retraction device 200 at a desired position in the longitudinal direction or at a rotation angle around a predetermined axis. Furthermore, operation parts 308 and 309 are provided on both sides for operating the fixing portion 307 with a remote control tool. With this support 300b, an operation for changing the direction of the right-side end of the coated electric wire after cutting (sorting operation) can be performed so that the ends of the coated electric wire after cutting do not come into contact with each other.

Such a wire tensioning device 100 (the extension/retraction device 200 including a pair of wire grippers 1 at both ends thereof) is used, for example, in the following manner. First, the pair of supports 300a and 300b are hooked onto the coated electric wire. Next, the wire gripper 1 on the right side grips a predetermined portion of the coated electric wire, and the wire gripper 1 on the left side grips a predetermined portion of the coated electric wire. Then, the operation part 205 is operated to retract the longitudinal dimension of the extension/retraction device 200, so that the pair of wire grippers 1 gripping the coated electric wire (an example of the wire-like body Ln) is brought close to each other. This allows the coated electric wire to be kept taut outside the wire gripper 1 of the coated electric wire and to be loosened in the portion of the coated electric wire between the two wire grippers 1, and then the loosened portion of the coated electric wire is cut with a cutting tool for an indirect live wire. On the other hand, the operation part 205 can be operated to extend the longitudinal dimension of the extension/retraction device 200, so that the pair of wire grippers 1 gripping the coated electric wire (an example of the wire-like body Ln) is separated from each other. According to such an aspect, the wire gripper 1 can be operated in a simple manner, thereby enabling wire tensioning work to be performed quickly and safely.

<Wire gripper 1>

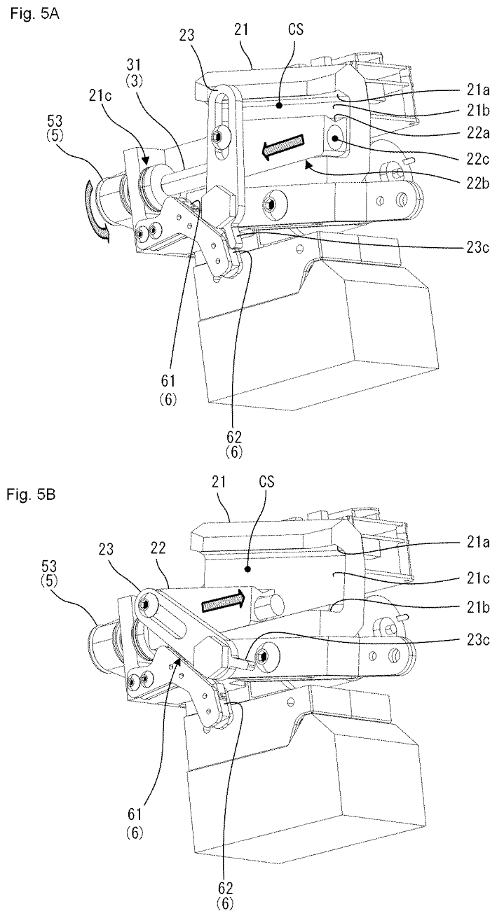

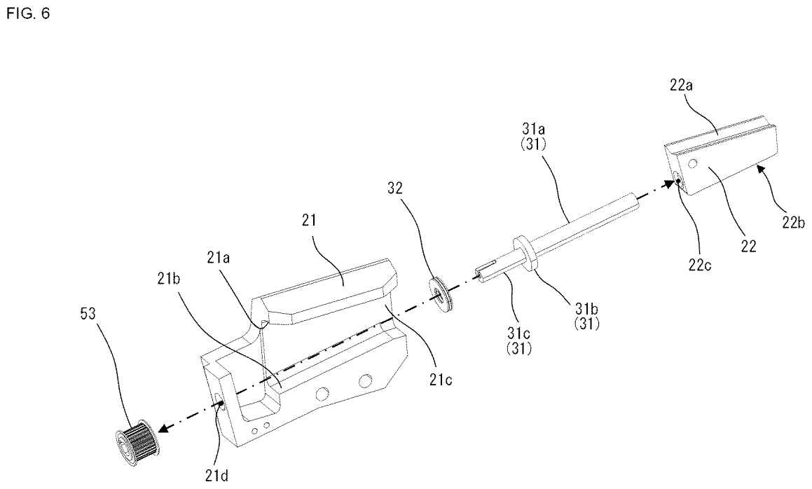

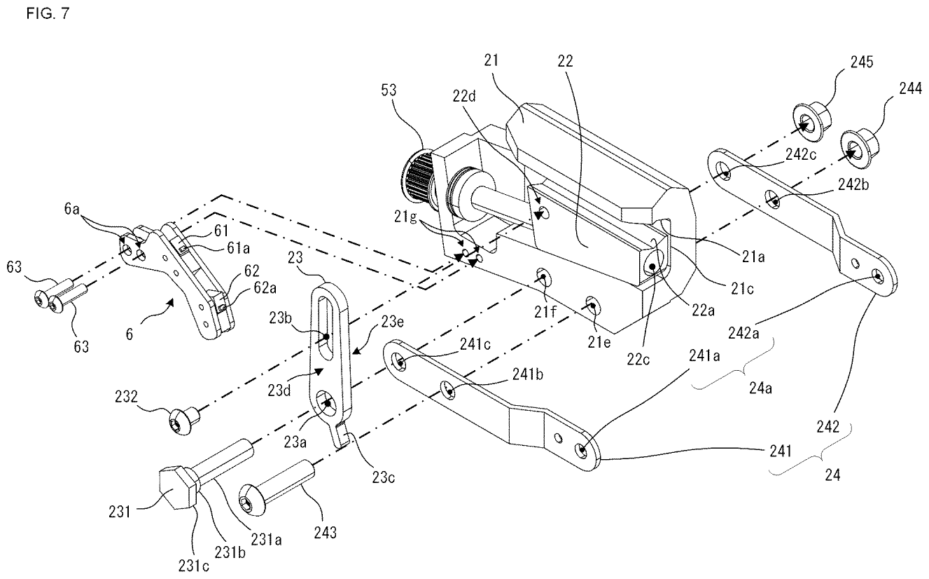

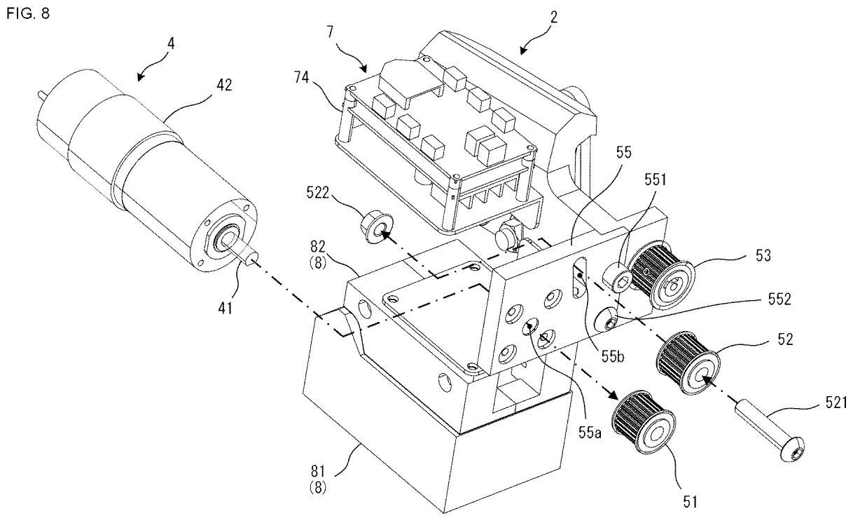

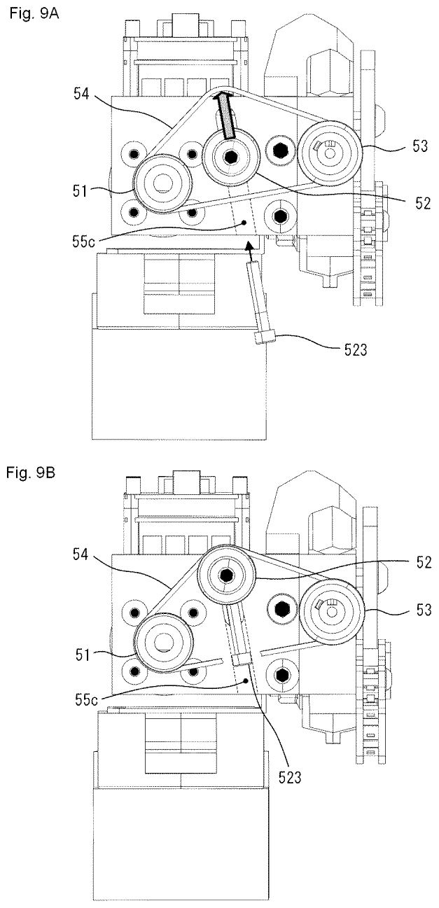

Next, the wire gripper 1 will be described. FIG. 4, FIG. 5A, and FIG. 5B are perspective views showing a wire gripper 1 according to the present embodiment. FIG. 6 is an exploded perspective view showing the configuration of a wire gripping portion 2 and a displacement mechanism 3. FIG. 7 is an exploded perspective view showing the configuration of the wire gripping portion 2 and a wire-type detection mechanism 6. FIG. 8 is an exploded perspective view showing the configuration of a motor 4 and a transmission mechanism 5. FIG. 9A and FIG. 9B are left side views showing the configuration of the transmission mechanism 5.

The wire gripper 1 shown in FIG. 4 is a device adapted to be used to grip a wire-like body Ln, and includes a wire gripping portion 2, a displacement mechanism 3, a motor 4, a transmission mechanism 5, a wire-type detection mechanism 6, a control board 7, and a power supply part 8.

As shown in FIG. 4 to FIG. 6, the wire gripping portion 2 includes a first member 21, a second member 22, a third member 23, and a connecting member 24. The displacement mechanism 3 includes a screw shaft 31 and a washer 32. In the following description, the first member 21, the second member 22, and the displacement mechanism 3 will be described first.

The first member 21 is made of a block-shaped member and includes a tapered groove 21c and a through hole 21d. The groove 21c has, on its inner surface, a wire-gripping surface 21a and an inclined surface 21b, which are provided so as to face each other. The second member 22 is formed of a block-shaped member and includes a wire-gripping surface 22a, a sliding surface 22b, and a threaded hole 22c. The second member 22 has the wire-gripping surface 22a and the sliding surface 22b on opposite surfaces, respectively. Furthermore, the first member 21 and the second member 22 are arranged such that the inclined surface 21b and the sliding surface 22b are brought into contact with each other. In other words, the second member 22 is arranged so as to be in contact with a part of the groove 21c of the first member 21. As a result, the wire gripping portion 2 is provided with the wire-gripping surface 21a and the wire-gripping surface 22a at positions facing each other, thereby forming a gripping space CS for gripping the wire-like body Ln between the wire-gripping surface 21a and the wire-gripping surface 22a. That is, with these configurations, the gripping space CS is formed in a gap where the first member 21 and the second member 22 are not in contact with each other.

In the present embodiment, the wire-gripping surface 21a and the wire-gripping surface 22a each have a V-shaped groove for gripping the wire-like body Ln. Instead of the V-shaped grooves, the wire-gripping surface 21a and the wire-gripping surface 22a may each have an arc-shaped groove or other types of grooves. More preferably, the wire-gripping surface 21a and the wire-gripping surface 22a may each be provided with a non-slip means for the wire-like body Ln. Examples of such a non-slip means include the formation of pointed fine protrusions, the formation of fine ridges extending in the lateral direction, and the attachment of a rubber member.

Furthermore, the first member 21 and the second member 22 are configured such that the gripping space CS changes in size in accordance with the displacement of the positional aspect. The positional aspect includes a first aspect and a second aspect. The first aspect is a positional aspect that narrows the size of the gripping space CS, thereby enabling the wire-like body Ln to be gripped. The second aspect is a positional aspect that enlarges the size of the gripping space CS, thereby releasing the gripping of the wire-like body Ln. In other words, the positional aspects are configured such that the wire-like body Ln is gripped in the first aspect, and the gripping of the wire-like body Ln is released in the second aspect.

In the present embodiment, the first member 21 is fixed, and the second member 22 is configured to be displaced along the longitudinal direction of the wire-like body Ln by sliding relative to the first member 21. That is, the second member 22 is a block-shaped slider. Preferably, the second member 22 has a shape of a wedge, a prism, a square pyramid, or a truncated square pyramid. According to such an aspect, the wire-like body Ln can be more firmly gripped by the wedge effect, thereby enabling the wire tensioning work to be performed quickly and safely. More preferably, the first member 21 and the second member 22 are engaged with each other by a shape extending along the sliding direction. Such a shape extending along the sliding direction may be, for example, a configuration in which a convex shape is provided on one side and a concave shape is provided on the other side. Furthermore, the wire gripping portion 2 may be configured to displace both the first member 21 and the second member 22, or may be configured to displace the first member 21 relative to the second member 22 that is fixed.

Specifically, as shown in FIG. 6, the first member 21 that is fixed has a through hole 21d, and the second member 22 that slides relative to the first member 21 has a threaded hole 22c. Noted that the first member 21 may be configured to have a threaded hole, and the second member 22 may be configured to have a through hole. That is, at least one of the first member 21 and the second member 22 has a threaded hole (for example, the threaded hole 22c). In addition, the through hole 21d and the threaded hole 22c are respectively provided at positions facing each other along the sliding direction of the second member 22. The sliding direction of the second member 22 is substantially identical to the longitudinal direction of the wire-like body Ln.

The screw shaft 31 has a thread portion 31a on one side in the longitudinal direction and a shaft portion 31c on the other side in the longitudinal direction. In addition, the screw shaft 31 includes a flange portion 31b between the thread portion 31a and the shaft portion 31c.

The shaft portion 31c (screw shaft 31) is inserted through the washer 32, with the flange portion 31b contacting with the washer 32. The shaft portion 31c is inserted through the through hole 21d (first member 21), and a portion protruding from the first member 21 (a part of the shaft portion 31c) is fitted with a timing pulley 53 of the transmission mechanism 5 (details of the transmission mechanism 5 will be described later). As a result, the screw shaft 31 which serves as the displacement mechanism 3 is rotatably mounted in the through hole 21d (first member 21) while being restricted from displacement in the axial direction. Furthermore, the thread portion 31a (screw shaft 31) is threadedly engaged with the threaded hole 22c of the second member 22. In other words, the displacement mechanism 3 includes the screw shaft 31 that is threadedly engaged with the threaded hole 22c. With such a configuration, by the rotation of the screw shaft 31, the threaded hole 22c (a part of the second member 22) and the through hole 21d (a part of the first member 21) approach each other or are spaced apart from each other along the longitudinal direction of the wire-like body Ln. That is, the displacement mechanism 3 is configured to allow the second member 22 to be displaced along the longitudinal direction of the wire-like body Ln, while the first member 21 is fixed. In other words, the displacement mechanism 3 is configured to displace at least one of the first member 21 and the second member 22 in the longitudinal direction of the wire-like body Ln.

In addition, the size of the gripping space CS changes in accordance with the position of the second member 22 in the longitudinal direction of the wire-like body Ln. That is, the gripping space CS changes in size in accordance with the position of at least one of the first member 21 and the second member 22 in the longitudinal direction.

Specifically, the displacement mechanism 3 displaces the second member 22 along the inclined surface 21b of the groove 21c having a tapered shape. The tapered shape of the groove 21c is, as described above, configured by the wire-gripping surface 21a and the inclined surface 21b arranged to face the wire-gripping surface 21a. The wire-gripping surface 21a is a surface provided so as to extend along the longitudinal direction of the wire-like body Ln, and the inclined surface 21b is a surface provided so as to face the wire-gripping surface 21a in an inclined manner. In other words, the distance between the wire-gripping surface 21a and the inclined surface 21b is close to each other on one side and away from each other on the other side in the longitudinal direction of the wire-like body Ln.

When the second member 22 is displaced toward the side where the distance between the wire-gripping surface 21a and the inclined surface 21b is close to each other, the distance between the wire-gripping surface 21a and the wire-gripping surface 22a is also close to each other, thereby narrowing the size of the gripping space CS. That is, the positional aspect of the wire gripping portion 2 can be displaced to the first aspect by the displacement mechanism 3. Furthermore, when the second member 22 is displaced toward the side where the distance between the wire-gripping surface 21a and the inclined surface 21b is away from each other, the distance between the wire-gripping surface 21a and the wire-gripping surface 22a is also away from each other, thereby enlarging the size of the gripping space CS. That is, the positional aspect of the wire gripping portion 2 can be displaced to the second aspect by the displacement mechanism 3. In other words, the displacement mechanism 3 is configured to displace the positional aspect between the first member 21 and the second member 22, so that the gripping space CS changes in size.

As shown in FIG. 5A and FIG. 5B, when the screw shaft 31 is rotated in the direction of tightening relative to the threaded hole 22c (for example, right rotation in the case of a right-hand screw) in the state illustrated in FIG. 5A, the threaded hole 22c (a part of the second member 22) is displaced so as to approach the through hole 21d (a part of the first member 21) (see the bold arrow in the substantially left direction in FIG. 5A). This displacement causes the wire gripping portion 2 to change from the state shown in FIG. 5A to the state shown in FIG. 5B, thereby displacing the positional aspect thereof so as to enlarge the size of the gripping space CS. That is, by displacing the positional aspect of the wire gripper 1 to the second aspect, it is possible to release the gripping of the wire-like body Ln (not shown), or to prepare for gripping the wire-like body Ln thereafter.

In the state shown in FIG. 5B, when the screw shaft 31 is rotated in the direction of loosening relative to the threaded hole 22c (for example, left rotation in the case of a right-hand screw), the threaded hole 22c (a part of the second member 22) is displaced so as to move away from the through hole 21d (a part of the first member 21) (see the bold arrow in the substantially right direction in FIG. 5B). This displacement causes the wire gripping portion 2 to change from the state shown in FIG. 5B to the state shown in FIG. 5A, thereby displacing the positional aspect thereof so as to narrow the size of the gripping space CS. That is, the wire-like body Ln (not shown) can be gripped by displacing the positional aspect of the wire gripper 1 to the first aspect.

Next, the third member 23 will be described. The third member 23 is made of a narrow plate piece and is rotatably attached to each of the first member 21 and the second member 22. The third member 23 is arranged so as to be adjacent to each of the first member 21 and the second member 22, thereby being arranged so as to be a part forming the gripping space CS. That is, the displacement mechanism 3 is configured to displace the third member 23 in association with the displacement of the positional aspect of the wire gripping portion 2. In other words, the third member 23 is configured such that its position and orientation are displaced in association with the displacement of the positional aspects of the first member 21 and the second member 22.

The first aspect is a positional aspect in which a hole through which the wire-like body Ln can be inserted is formed by the first member 21, the second member 22, and the third member 23. As a result, the wire-like body Ln can be retained in the gripping space CS. The second aspect is a positional aspect in which a gap that allows the wire-like body Ln to be inserted into and removed from the gripping space CS is formed. As a result, the wire-like body Ln can be inserted into and removed from the gripping space CS. In other words, in the first aspect, a hole through which the wire-like body Ln is insertable is formed in at least a part of the gripping space CS, whereas in the second aspect, a gap that allows the wire-like body Ln to be inserted into and removed from the gripping space CS is formed. Hereinafter, details will be described.

As shown in FIG. 7, a through hole 23a of the third member 23 is provided so as to penetrate from a front surface 23d to a rear surface 23e of the third member 23. A cylindrical portion 231b of a stepped bolt 231 is inserted through the through hole 23a, and a screw head 231c comes into contact with the front surface 23d. Then, a threaded portion 231a is inserted through a through hole 241c of a connecting member 241 (a part of a connecting member 24), a through hole 21f of the first member 21, and a through hole 242c of a connecting member 242 (a part of the connecting member 24), and a nut 245 is threadedly engaged with a portion protruding from the through hole 242c. Noted that details of the connecting member 24 will be described later. Furthermore, a bolt 232 is inserted into a through hole 23b of the third member 23, and the bolt 232 is threadedly engaged with a threaded hole 22d of the second member 22. As a result, the third member 23 is rotatably attached to each of the first member 21 and the second member 22.

In the state shown in FIG. 5A, the third member 23 is arranged so as to be adjacent to the wire-gripping surface 21a of the first member 21 and the wire-gripping surface 22a of the second member 22. As a result, the third member 23 is arranged to form a part of the gripping space CS, and a hole through which the wire-like body Ln can be inserted is formed by the first member 21, the second member 22, and the third member 23. When the state changes from the first aspect shown in FIG. 5A to the second aspect shown in FIG. 5B, the third member 23 is displaced in association with the displacement of the second member 22. As a result, the third member 23 is displaced so as to move away from the first member 21, thereby forming a gap in the gripping space CS that allows the wire-like body Ln to be inserted into or removed therefrom. That is, when the displacement is made from the second aspect to the first aspect, namely, in a case where the wire-like body Ln that has not yet been gripped is inserted into the gripping space CS, the wire gripping portion 2 is configured to retain the wire-like body Ln, before being gripped, within the gripping space CS by the displacement of the third member 23. According to such an aspect, the work of attaching the wire-like body Ln to the wire gripper 1 is further simplified, thereby enabling wire tensioning work to be performed quickly and safely.

Next, the connecting member 24 will be described. As shown in FIG. 4 and FIG. 7, the connecting member 24 is made of a narrow plate piece and includes connecting members 241 and 242. The connecting member 241 and the connecting member 242 are mounted so as to sandwich the first member 21, and a through hole 24a is formed by overlapping a through hole 241a of the connecting member 241 and a through hole 242a of the connecting member 242. A bolt 243 is inserted through a through hole 241b of the connecting member 241, and the screw head of the bolt 243 comes into contact with the through hole 241b. The bolt 243 is further inserted through a through hole 21e of the first member 21 and the through hole 242b of the connecting member 242, and a nut 244 is threadedly engaged with the portion protruding from the through hole 242b. As described above, the stepped bolt 231 is inserted through the through hole 241c of the connecting member 241 and the through hole 242c of the connecting member 242, and is threadedly engaged with the nut 245. The connecting member 24 is thus fixed to the first member 21 by the above configuration, and the coupling tool 400 of the wire tensioning device 100 is connected to the through hole 24a.

As shown in FIG. 8, FIG. 9A and FIG. 9B, the motor 4 includes a rotary shaft 41 and a case 42, and the transmission mechanism 5 includes timing pulleys 51 to 53, a timing belt 54, and a plate 55. The case 42 is fixed to the plate 55, and the rotary shaft 41 is inserted through a through hole 55a of the plate 55. The timing pulley 51 is fitted with the portion of the rotary shaft 41 that protrudes from the through hole 55a. A bolt 521 is inserted through the timing pulley 52, and the head of the bolt 521 is in contact with the timing pulley 52. The bolt 521 is further inserted through a through hole 55b of the plate 55, and a nut 522 is threadedly engaged with the portion of the bolt 521 that protrudes from the through hole 55b. The timing pulley 53 is, as described above, fitted with the screw shaft 31. The plate 55 is threadedly engaged with the first member 21 by bolts 551 and 552. With the above configuration, the timing pulleys 51 to 53 are arranged so that the timing belt 54 for transmitting power can be looped around them.

As shown in FIG. 9A, the timing belt 54 is mounted to the wire gripper 1 by being looped around the timing pulleys 51 to 53. By threading a bolt 523 into a threaded hole 55c and tightening the bolt 523, the timing pulley 52 is displaced (see the thick arrow pointing substantially upward in FIG. 9A). As shown in FIG. 9B, the timing pulley 52 is displaced by tightening the bolt 523, thereby allowing the timing belt 54 to be adjusted to a predetermined tension. By adjusting the timing belt 54 to the predetermined tension, the transmission mechanism 5 can smoothly transmit power from the motor 4 to the screw shaft 31. According to such a configuration, the rotational force of the rotary shaft 41 of the motor 4 can be transmitted to the screw shaft 31 of the displacement mechanism 3 via the timing pulleys 51 to 53 and the timing belt 54. That is, the timing pulleys 51 to 53 and the timing belt 54 constitute a rotational force transmission mechanism. With the above configuration, the motor 4 is configured to generate rotational power for imparting power to the displacement mechanism 3, and specifically, the motor 4 is configured to impart power to the screw shaft 31. According to such an aspect, the wire gripper 1 can be operated with higher precision, thereby enabling the wire tensioning work to be performed quickly and safely. Furthermore, the transmission mechanism 5 is configured to transmit the rotational power generated by the motor 4 to the displacement mechanism 3, and specifically, the transmission mechanism 5 is configured with a belt (for example, the timing belt 54) or a gear. According to such an aspect, the wire gripper 1 can be further miniaturized. It should be noted that the configuration is not limited to the threaded engagement between the screw shaft 31 of the displacement mechanism 3 and the threaded hole 22c of the second member 22. For example, a rack-and-pinion mechanism may also be adopted. In this case, at least one of the first member 21 and the second member 22 is configured to include a rack, and the displacement mechanism 3 includes a pinion that meshes with the rack, thereby forming the rack-and-pinion mechanism. Furthermore, the motor 4 is configured to impart power to the pinion. According to such an aspect, the wire gripper 1 can be operated with higher precision, thereby enabling wire tensioning work to be performed quickly and safely.

As shown in FIG. 4, FIG. 5, and FIG. 7, the wire-type detection mechanism 6 is configured in a block shape. A bolt 63 is inserted into the through hole 6a of the wire-type detection mechanism 6, and a threaded hole 21g of the first member 21 is threadedly engaged with the portion of the bolt 63 protruding from the through hole 6a. Accordingly, the wire-type detection mechanism 6 is fixed to the first member 21.

The wire-type detection mechanism 6 includes a first position sensor 61 and a second position sensor 62, and the first position sensor 61 and the second position sensor 62 include a button 61a and a button 62a, respectively. The third member 23 is provided in the vicinity of the wire-type detection mechanism 6, and the third member 23 is configured to push either the button 61a or the button 62a in association with the displacement of the positional aspect of the wire gripping portion 2. Specifically, as shown in FIG. 5A, when the gripping space CS is narrowed to a predetermined size, the button 62a is pushed by a protrusion 23c of the third member 23. Further, as shown in FIG. 5B, when the gripping space CS is enlarged to a predetermined size, the button 61a is pushed by the side surface of the third member 23. The first position sensor 61 and the second position sensor 62 can be turned on by pushing the buttons 61a and 62a.

In the present embodiment, the motor 4 includes an encoder 60 (not shown) inside thereof, which is configured to measure the number of rotations of the rotary shaft 41. That is, the wire-type detection mechanism 6 further includes the encoder 60, and the encoder 60 is configured to measure the number of rotations of the motor 4. Examples of the encoder 60 include an optical type, a mechanical (contact) type, a magnetic type, and an electromagnetic induction type. In the present embodiment, the encoder 60 is provided inside the motor 4, the present disclosure is not limited thereto. For example, the encoder 60 may be provided in the displacement mechanism 3, the transmission mechanism 5, or the like.

According to such a configuration, as shown in FIG. 5B, the position at which the side surface of the third member 23 pushes the button 61a of the first position sensor 61, that is, the position where the size of the gripping space CS is maximally enlarged, can be specified as the position at which the encoder 60 starts to measure the number of rotations of the rotary shaft 41. With this position as a reference point, the encoder 60 measures the number of rotations of the rotary shaft 41. Furthermore, when the wire-like body Ln is gripped by the wire gripping portion 2, the rotation of the rotary shaft 41 of the motor 4 stops or slows down at the position where the wire-like body Ln is gripped. That is, the wire gripper 1 can specify the state in which the wire-like body Ln is being gripped, by detecting the change in the angular velocity of the rotary shaft 41 using the encoder 60. Alternatively, the wire gripper 1 may also specify the state in which the wire-like body Ln is being gripped, by recognizing the change in the current value during the operation of the motor 4. With such a configuration, the wire gripper 1 can measure the thickness (outer diameter) of the wire-like body Ln that is being gripped by the wire gripping portion 2. It is possible to detect the type of the wire-like body Ln by comparing this measurement result with a database. In other words, the first position sensor 61 is configured to specify the position at which the measurement of the number of rotations is started, thereby detecting the type of the wire-like body Ln that is being gripped by the wire gripping portion 2. According to such an aspect, the wire gripper 1 can detect the type of the wire-like body Ln, and the wire tensioning work can be performed quickly and safely.

In contrast, when the protrusion 23c of the third member 23 pushes the button 62a of the second position sensor 62, the gripping space CS is in a state narrowed to a predetermined size, and therefore, it is possible to configure to stop the power supply to the motor 4. In other words, the second position sensor 62 is configured to specify the position at which the rotation of the motor 4 is stopped. According to such an aspect, deterioration or breakage of the wire gripper 1 can be preferably prevented.

It should be noted that the wire-type detection mechanism 6 for detecting the type of the wire-like body Ln that is being gripped by the wire gripping portion 2 is not limited to the above configuration. For example, the wire-type detection mechanism 6 may be configured by providing a pressure sensor on the wire-gripping surface 21a of the first member 21 and the wire-gripping surface 22a of the second member 22, or by providing a sensor for measuring the distance between the first member 21 and the second member 22.

As shown in FIG. 4 and FIG. 8, the power supply part 8 is arranged below the motor 4 and includes a battery 81 and a battery mounting portion 82. The battery 81 is detachably mounted to the battery mounting portion 82, and the battery mounting portion 82 is fixed to the wire gripping portion 2. The power supply part 8 is configured to supply power to at least the motor 4. Note that the battery 81 may be, for example, a primary battery such as a dry cell or solar cell, or a secondary battery such as a lithium ion battery.

As shown in FIG. 4 and FIG. 8, the control board 7 is mounted on a support stand 74, and the support stand 74 is fixed to the wire gripping portion 2. Note that a cover (not shown) covering the control board 7 is preferably provided.

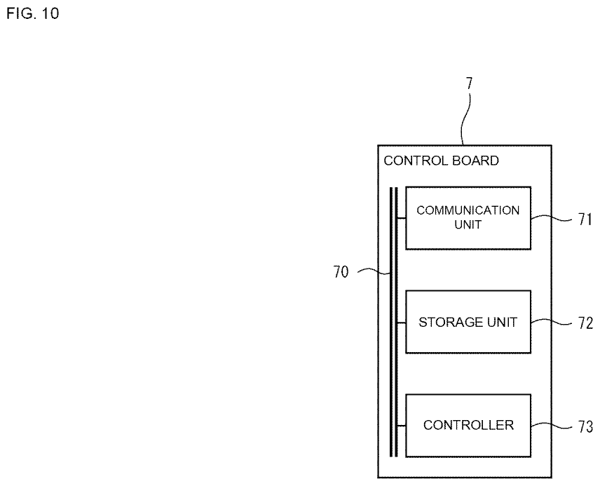

FIG. 10 is a block diagram showing the configuration of the control board 7. The control board 7 shown in FIG. 10 is, for example, a dedicated control apparatus that controls at least the motor 4, and is configured to electrically control at least the rotation of the motor 4. The control board 7 includes a communication unit 71, a storage unit 72, and a controller 73, which are electrically connected via a communication bus 70. In addition to the motor 4, the wire-type detection mechanism 6 and the power supply part 8 are electrically connected to the control board 7.

The communication unit 71 is configured to transmit various electric signals from the control board 7 to an external component. Furthermore, the communication unit 71 is configured to receive various electrical signals from an external component to the control board 7. More preferably, the communication unit 71 has a network communication function, and thus various kinds of information may be communicated with an external apparatus via a network such as the Internet.

It is preferable for the communication unit 71 to include wired communication means such as USB, IEEE 1394, Thunderbolt (registered trademark), and wired LAN network communication. It may also include wireless LAN network communication, mobile communication such as 3G/LTE/5G, and BLUETOOTH (registered trademark) communication as necessary. That is, it is more preferable to implement the communication unit 71 as a set of these multiple types of communication means.

The storage unit 72 stores various types of information defined by the foregoing description. For example, this may be implemented as a storage device such as a solid-state drive (SSD) that stores various programs pertaining to the wire gripper 1 that are executed by the controller 73, or as a memory such as random-access memory (RAM) that stores temporarily required information (such as arguments and arrays) pertaining to the program operations. The storage unit 72 stores various programs, variables, etc. related to the wire gripper 1 that are executed by the controller 73. Particularly preferably, information on the construction plan to be performed using the wire gripper 1 is stored.

The controller 73 processes and controls overall operation pertaining to the wire gripper 1. The controller 73 is, for example, an unshown central processing unit (CPU). The controller 73 implements various functions pertaining to the wire gripper 1 by reading a predetermined program stored in the storage unit 72. In other words, the controller 73 as an example of hardware is configured to concretely implement information processing of software stored in the storage unit 72. The controller 73 is not limited to being a single controller but may be implemented with a plurality of controllers 73 for each function. Moreover, a combination thereof may be applied.

Next, the use of the wire gripper 1 (wire tensioning device 100) will be described using an example in which a coated electric wire (an example of the wire-like body Ln) is gripped.

[1] First, the supports 300a and 300b are hooked onto the coated electric wire. Then, a pair of wire grippers 1 coupled to both ends of the extension/retraction device 200 is mounted to the coated electric wire using a remote control tool. Specifically, the first member 21, the second member 22, and the third member 23 are displaced to the second aspect, the coated electric wire is inserted into the gripping space CS, and the wire-gripping surface 21a of the first member 21 is hooked onto the coated electric wire.

[2] Next, the wire gripper 1 is activated by using an external terminal (not shown.)

At that time, in the controller 73 of the control board 7, a determination is performed as to whether the position at which the encoder 60 starts to measure the number of rotations of the rotary shaft 41 has been specified. If it has not been specified, a learning operation is executed. Specifically, the control board 7 controls the operation of the motor 4 in response to a user's operation or automatically until the button 61a of the first position sensor 61 is pushed by the side surface of the third member 23. When the button 61a is pushed by the side surface of the third member 23 and the control board 7 receives an input from the first position sensor 61, the control board 7 stops the operation of the motor 4 and specifies the position at which the encoder 60 starts to measure the number of rotations of the rotary shaft 41. It should be noted that the learning operation may be executed each time the wire gripper 1 is used. For example, the learning operation may be controlled by the control board 7 so that the positional aspect of the wire gripper 1 after use is set as the learning position. Alternatively, the learning operation may be executed when the number of times the wire gripper 1 is used reaches a predetermined number, when the usage period/time of the wire gripper 1 reaches a predetermined period/time, or the like.

[3] Next, an external terminal (not shown) is used to operate the motor 4, which rotates the screw shaft 31 of the displacement mechanism 3 in a predetermined direction via the transmission mechanism 5. As a result, the second member 22 that is threadedly engaged with the screw shaft 31 slides relative to the first member 21, and the third member 23 rotates relative to the first member 21 and the second member 22. When the third member 23 rotates, the first member 21, the second member 22, and the third member 23 form a hole in the gripping space CS through which the coated electric wire can be inserted. Accordingly, the coated electric wire before being gripped can be retained within the gripping space CS. In addition, the wire-gripping surface 21a of the first member 21 and the wire-gripping surface 22a of the second member 22 are brought close to each other by the sliding of the second member 22, thereby narrowing the size of the gripping space CS, and thus the coated electric wire can be gripped. As a result, the pair of wire grippers 1 can be fixed to the coated electric wire.

In addition, the wire gripper 1 recognizes the change in angular velocity of the rotary shaft 41 based on the input of the encoder 60, and when the rotation of the rotary shaft 41 of the motor 4 stops or slows down, the operation of the motor 4 is stopped. Alternatively, the wire gripper 1 may stop the operation of the motor 4 in response to the operation of the external terminal by the user. This maintains the first aspect by the first member 21 and the second member 22, and the state in which the coated electric wire is gripped can be continued. In addition, in the wire-type detection mechanism 6, the type of the coated electric wire being gripped is detected using the measurement result of the thickness (outer diameter) of the coated electric wire. The result thereof is notified to an external terminal (not shown). Furthermore, in the case where the coated electric wire to be gripped has been registered in advance by the user, it is determined whether the coated electric wire that is being gripped by the wire gripper 1 matches the registered coated electric wire, and the result thereof is notified to the external terminal (not shown).

[4] When cutting the coated electric wire, the operation part 205 is operated by the remote control tool to retract the longitudinal dimension of the extension/retraction device 200, thereby bringing the wire grippers 1 closer to each other. This allows the coated electric wire to be kept taut outside the wire grippers 1 of the coated electric wire, and to be loosened in the portion of the coated electric wire between the two wire grippers 1.

[5] After the work is completed, the operation part 205 is operated by the remote control tool to extend the longitudinal dimension of the extension/retraction device 200, so that the wire grippers 1 are separated from each other. Subsequently, the motor 4 is driven by using the external terminal, and the screw shaft 31 of the displacement mechanism 3 is rotated in the reverse direction to the above direction via the transmission mechanism 5. This displaces the first member 21 and the second member 22 from the first aspect to the second aspect, thereby releasing the gripping of the coated electric wire. Finally, the wire tensioning device 100 is removed from the coated electric wire by using the remote control tool.

As described above, according to the present embodiment, the gripping operation of the coated electric wire by the wire gripper 1 is configured to be performed by the motor 4. Therefore, since the wire gripper 1 itself assists with work requiring a large force, the operability is improved. In addition, conventionally, the work was performed by two workers boarding a bucket in the air, but it becomes possible for one worker to perform the work, and thus workability is also improved. Furthermore, since the remaining one worker can grasp the working state of the worker on the bucket from the ground and give accurate instructions, safety is also enhanced. According to such an aspect, the wire gripper 1 can be operated in a simple manner, thereby enabling wire tensioning work to be performed quickly and safely.

Furthermore, by attaching various sensors to the wire gripper 1, data obtained during work can be transmitted to an external terminal (such as a tablet terminal, etc.) via the communication unit 71 of the control board 7 and can be stored there. Then, it is possible to check the work history and manage the need for repairs, etc. to the wire gripper 1 based on the obtained data, which is also preferable from the viewpoint of improving safety. The external terminal may be a foot switch, a voice recognition device, etc. In this case, even in the case of working alone, both hands can be freed when operating the wire gripper 1. In addition, even in the case where a plurality of coated electric wires are simultaneously worked on using the respective wire tensioning devices 100, the wire tensioning work and the like can be performed using a single external terminal.

In addition, the present disclosure may be provided in each of the following aspects.

(1) A wire gripper adapted to be used to grip a wire-like body, comprising: a wire gripping portion that includes a first member and a second member, the first member including a tapered groove, the second member being arranged so as to be in contact with a part of the groove, thereby forming a gripping space in a gap where the second member is not in contact with the groove; a displacement mechanism configured to displace a positional aspect between the first member and the second member, so that the gripping space changes in size, the positional aspect including a first aspect and a second aspect, in the first aspect, the wire-like body being gripped by the wire gripping portion, in the second aspect, gripping of the wire-like body by the wire gripping portion being released; and a motor configured to generate rotational power for imparting power to the displacement mechanism.

According to such an aspect, the wire gripper can be operated in a simple manner, thereby enabling wire tensioning work to be performed quickly and safely.

(2) The wire gripper according to (1), wherein: the first member is fixed, and the second member is a slider configured to slide relative to the first member.

(3) The wire gripper according to (1) or (2), wherein: the second member has a shape of a wedge, a prism, a square pyramid, or a truncated square pyramid.

According to such an aspect, the wire-like body can be more firmly gripped by the wedge effect, thereby enabling the wire tensioning work to be performed quickly and safely.

(4) The wire gripper according to any one of (1) to (3), wherein: the displacement mechanism is configured to displace at least one of the first member and the second member in a longitudinal direction of the wire-like body, and the gripping space changes in size in accordance with a position in the longitudinal direction.

(5) The wire gripper according to any one of (1) to (4), wherein: at least one of the first member and the second member has a threaded hole, the displacement mechanism includes a screw shaft that is threadedly engaged with the threaded hole, and the motor is configured to impart power to the screw shaft.

According to such an aspect, the wire gripper can be operated with higher precision, thereby enabling the wire tensioning work to be performed quickly and safely.

(6) The wire gripper according to any one of (1) to (4), wherein: at least one of the first member and the second member includes a rack, the displacement mechanism includes a pinion that meshes with the rack, thereby forming a rack-and-pinion mechanism, and the motor is configured to impart power to the pinion.

According to such an aspect, the wire gripper can be operated with higher precision, thereby enabling the wire tensioning work to be performed quickly and safely.

(7) The wire gripper according to any one of (1) to (6), further comprising: a transmission mechanism configured to transmit rotational power generated by the motor to the displacement mechanism.

(8) The wire gripper according to (7), wherein: the transmission mechanism is a belt or a gear.

According to such an aspect, the wire gripper can be further miniaturized.

(9) The wire gripper according to any one of (1) to (8), wherein: the wire gripping portion further includes a third member arranged so as to be a part forming the gripping space, the displacement mechanism is configured to displace the third member in association with displacement of the positional aspect, in the first aspect, a hole through which the wire-like body is insertable is formed in at least a part of the gripping space, and in the second aspect, a gap that allows the wire-like body to be inserted into and removed from the gripping space is formed.

According to such an aspect, the operation of attaching the wire-like body to the wire gripper is further simplified, thereby enabling wire tensioning work to be performed quickly and safely.

(10) The wire gripper according to any one of (1) to (9), further comprising: a wire-type detection mechanism including an encoder and a first position sensor, wherein the encoder is configured to measure a number of rotations of the motor, and the first position sensor is configured to specify a position at which measurement of the number of rotations is started, thereby detecting a type of the wire-like body that is being gripped by the wire gripping portion.

According to such an aspect, the wire gripper can detect the type of the wire-like body, and the wire tensioning work can be performed quickly and safely.

(11) The wire gripper according to any one of (1) to (10), further comprising: a second position sensor configured to specify a position at which rotation of the motor is stopped.

According to such an aspect, deterioration or breakage of the wire gripper can be preferably prevented.

(12) The wire gripper according to any one of (1) to (11), further comprising: a control board configured to electrically control at least rotation of the motor.

(13) The wire gripper according to any one of (1) to (12), further comprising: a power supply part configured to supply power to at least the motor.

(14) A wire tensioning device, comprising: a pair of wire grippers each configured with the wire gripper according to any one of (1) to (13), and an extension/retraction device including the pair of wire grippers at both ends thereof and being configured so that the pair of wire grippers gripping the wire-like body is brought close to each other and is separated from each other.

According to such an aspect, the wire gripper can be operated in a simple manner, thereby enabling wire tensioning work to be performed quickly and safely.

Of course, the present disclosure is not limited to the above aspects.

Finally, various embodiments of the present disclosure have been described, but these are presented as examples and are not intended to limit the scope of the invention. Novel embodiments can be implemented in various other forms, and various omissions, replacements, and modifications can be made within the scope of the spirit of the invention. The embodiments and its modifications are included in the scope and the spirit of the invention and are included in the scope of the invention described in claims and the equivalent scope thereof.

1. A wire gripper adapted to be used to grip a wire-like body, comprising:
a wire gripping portion that includes a first member and a second member, the first member including a tapered groove, the second member being arranged so as to be in contact with a part of the groove, thereby forming a gripping space in a gap where the second member is not in contact with the groove;
a displacement mechanism configured to displace a positional aspect between the first member and the second member, so that the gripping space changes in size,
the positional aspect including a first aspect and a second aspect,
in the first aspect, the wire-like body being gripped by the wire gripping portion,
in the second aspect, gripping of the wire-like body by the wire gripping portion being released; and
a motor configured to generate rotational power for imparting power to the displacement mechanism.

2. The wire gripper according to claim 1, wherein:
the first member is fixed, and
the second member is a slider configured to slide relative to the first member.

3. The wire gripper according to claim 1, wherein:
the second member has a shape of a wedge, a prism, a square pyramid, or a truncated square pyramid.

4. The wire gripper according to claim 1, wherein:
the displacement mechanism is configured to displace at least one of the first member and the second member in a longitudinal direction of the wire-like body, and
the gripping space changes in size in accordance with a position in the longitudinal direction.

5. The wire gripper according to claim 1, wherein:
at least one of the first member and the second member has a threaded hole,
the displacement mechanism includes a screw shaft that is threadedly engaged with the threaded hole, and
the motor is configured to impart power to the screw shaft.

6. The wire gripper according to claim 1, wherein:
at least one of the first member and the second member includes a rack,
the displacement mechanism includes a pinion that meshes with the rack, thereby forming a rack-and-pinion mechanism, and
the motor is configured to impart power to the pinion.

7. The wire gripper according to claim 1, further comprising:
a transmission mechanism configured to transmit rotational power generated by the motor to the displacement mechanism.

8. The wire gripper according to claim 7, wherein:
the transmission mechanism is a belt or a gear.

9. The wire gripper according to claim 1, wherein:
the wire gripping portion further includes a third member arranged so as to be a part forming the gripping space,
the displacement mechanism is configured to displace the third member in association with displacement of the positional aspect,
in the first aspect, a hole through which the wire-like body is insertable is formed in at least a part of the gripping space, and
in the second aspect, a gap that allows the wire-like body to be inserted into and removed from the gripping space is formed.

10. The wire gripper according to claim 1, further comprising:
a wire-type detection mechanism including an encoder and a first position sensor, wherein
the encoder is configured to measure a number of rotations of the motor, and
the first position sensor is configured to specify a position at which measurement of the number of rotations is started, thereby detecting a type of the wire-like body that is being gripped by the wire gripping portion.

11. The wire gripper according to claim 1, further comprising:
a second position sensor configured to specify a position at which rotation of the motor is stopped.

12. The wire gripper according to claim 1, further comprising:
a control board configured to electrically control at least rotation of the motor.

13. The wire gripper according to claim 1, further comprising:
a power supply part configured to supply power to at least the motor.

14. A wire tensioning device, comprising:
a pair of wire grippers each configured by the wire gripper according to claim 1, and
an extension/retraction device including the pair of wire grippers at both ends thereof and being configured so that the pair of wire grippers gripping the wire-like body is brought close to each other and is separated from each other.
